(19) United States
(12) Patent Application Publication
(10) Pub. No.: US 2015/0131525 A1
(43) Pub. Date: May 14, 2015

(54) Method, Device, and System for Implementing Function Sharing in Wireless Access Hotspot Device

(71) Applicant: Jie Yang, Shenzhen (CN)

(72) Inventor: Jie Yang, Shenzhen (CN)

(73) Assignee: ZTE CORPORATION, Shenzhen, GD (CN)

(21) Appl. No.: 14/400,400

(22) PCT Filed: Jul. 13, 2012
(86) PCT No.: PCT/CN2012/078631

§ 371 Date: Nov. 11, 2014

(30) Foreign Application Priority Data
May 11, 2012 (CN) 201210146366.0

(51) Int. Cl. H04W 48/16; H04W 12/06

(52) U.S. Cl. CPC H04W 48/16; H04W 12/06
USPC 370/328

(57) ABSTRACT

Embodiments of the present invention provide a method, a device, and a system for implementing function sharing in a wireless access hotspot device. The method comprises: a wireless access hotspot device sends information of a function supported by the wireless access hotspot device to a terminal that passed authentication; the wireless access hotspot device receives a function sharing request message returned by the terminal, and obtains from the function sharing request message information of a function the terminal requests to share, the information of the function that is requested to share comprising a function that is successfully matched from the information of the function supported by the wireless access hotspot device and is capable of being shared by the terminal; and when the terminal enabling a function in the information of the shared function, the wireless access hotspot device sends application data corresponding to the function to the terminal in a wireless transmission manner. The present invention relates to the field of wireless communication devices. By means of the method of the present invention, one or more terminals can simultaneously access the wireless access hotspot device in a wireless manner and share their functions and the obtained related network information.

### TECHNICAL FIELD

This disclosure relates to the field of communication device including, e.g., a method, device, and system for implementing function sharing in a wireless access hotspot device.

### BACKGROUND

With the popularization of wireless access hotspot products, functions of the devices become increasingly rich. From only being able to provide the conversion from the wireless fidelity (Wi-Fi) access to the cellular access to complete configuration and management of network access, they have developed today to be able to support a variety of personalized applications, such as short message, multimedia message and the Global Position System (GPS) etc.

At present, a wireless access hotspot device supports a plurality of terminals to simultaneously access a wireless network, but if a terminal (a PC or other mobile terminals) needs to use applications on the wireless access hotspot device, it is necessary to be connected via a physical cable or wireless access hotspot device to be able to use the above various applications and services provided by the wireless access hotspot device. A problem brought is that because of the limitation of physical connection manner, only one terminal can be connected to the wireless access hotspot device during a period of time, which thus result in that only one terminal is able to use the applications and services on the wireless access hotspot device during some period of time. It is not convenient for the use of other users who want to use the applications and services on the wireless access hotspot device at the same time, causing wasting of the resources information on the wireless access hotspot device.

### SUMMARY

Embodiments of the disclosure provide a method, device, and system for implementing function sharing in a wireless access hotspot device to achieve that a plurality of users simultaneously use applications supported by the wireless access hotspot device, to make full use of the resources on the wireless access hotspot device.

According to an aspect of the disclosure, a method for implementing function sharing in a wireless access hotspot device is provided, comprising: a wireless access hotspot device sending information of a function supported by the wireless access hotspot device itself, to a terminal that passed wireless access authentication;

the wireless access hotspot device receiving a function sharing request message returned by the terminal, and obtaining, from the function sharing request message information of a function the terminal requests to share, wherein the information of the function that is requested to share comprises all kinds of functions that are successfully matched from the information of the function supported by the wireless access hotspot device and are capable of being shared by the terminal; and when the terminal enabling a function in the information of the shared function, the wireless access hotspot device sending application data corresponding to the function to the terminal in a wireless transmission manner. According to an embodiments of the disclosure, the wireless access hotspot device authenticates the terminal for access, comprises: when receiving an access request message sent by the terminal, the wireless access hotspot device sends a message to the terminal to request the terminal to provide an identity identification and an authentication algorithm supported by the terminal; and the wireless access hotspot device authenticating the terminal for access according to the returned identity identification and the authentication algorithm supported by the terminal.

According to an embodiments of the disclosure, after the wireless access hotspot device obtains from the function sharing request message the information of the function that the terminal requests to share, the method further comprising: the wireless access hotspot device saving the identity identification of the terminal and the received information of the function in the function sharing request message that the terminal requests to share correspondingly.

According to another aspect of the embodiments of the disclosure, a method for implementing function sharing in a wireless access hotspot device is provided. The method comprising: a terminal that passed wireless access authentication receiving from the wireless access hotspot device information of a function supported by the wireless access hotspot device itself; the terminal matching the information of a function supported by the terminal itself with the information of the function supported by the wireless access hotspot device to match out all kinds of the functions capable of being shared by the terminal, and sending a function sharing request message to the wireless access hotspot device, wherein all kinds of the matched-out functions as the information of the function that is requested are carried in the function sharing request message; and when the terminal enabling a function in the information of the shared function, receiving application data of the function returned by the wireless access hotspot device in a wireless transmission manner.

According to an embodiments of the disclosure, the terminal is required to be authenticated for access, comprising: sending an access request message to the wireless access hotspot device; sending an identity identification of the terminal and an authentication algorithm supported by the terminal to the wireless access hotspot device according to a request message for providing the identity identification and the supported authentication algorithm that is returned by the wireless access hotspot device; and receiving an authentication result returned by the wireless access hotspot device.

According to an embodiments of the disclosure, the method further comprising: after all kinds of functions capable of being shared by the terminal are matched out, the terminal loading the drive of the matched-out functions; and after receiving the application data sent by the wireless access hotspot device, the terminal completing obtaining and interpretation of the application data using an installed drive.

According to an embodiments of the disclosure, the wireless transmission manner is a wireless fidelity (Wi-Fi) manner.

According to yet another aspect of the embodiments of the disclosure, a wireless access hotspot device is provided, comprising: a sending component, configured to send information of a function supported by the wireless access hotspot device to a terminal that passed wireless access authentication; and when the terminal enabling a function in the information of a function that is requested to share, send application data corresponding to the function to the terminal in a wireless transmission manner; a receiving component, configured to receive a function sharing request message returned by the terminal; and an obtaining component, configured to obtain the information of the function that the terminal requests to share from the function sharing request message.

According to an embodiments of the disclosure, the wireless access hotspot device further comprising: an authentication component, configured to when receiving an access request message sent by the terminal, send a message to the terminal requesting access to request the terminal to provide an identity identification and an authentication algorithm supported by the terminal; and authenticate the terminal for access according to the returned identity identification and the authentication algorithm supported by the terminal.

According to an embodiments of the disclosure, the wireless access hotspot device further comprising: a memory component, configured to after obtaining the information of the function that the terminal requests to share from the function sharing request message, save the identity identification of the terminal and the received information of the function in the function sharing request message that the terminal requests correspondingly.

According to still another aspect of the embodiments of the disclosure, a terminal is provided, comprising: a receiving component, configured to receive from a wireless access hotspot device information of a function supported by the wireless access hotspot device itself; and when the terminal enables a function in the information of the function that is requested to share, receive application data of the function returned by the wireless access hotspot device in a wireless transmission manner; a matching component, configured to match information of a function supported by the terminal with information of a function supported by the wireless access hotspot device, and match out all kinds of functions capable of being shared by the terminal; a sending component, configured to send the function sharing request message to the wireless access hotspot device, wherein the matched-out kinds of functions capable of being shared by the terminal as the information of the function that is requested to share are carried in the function sharing request message.

According to an embodiments of the disclosure, the terminal further comprising: an authentication component, configured to send an access request message to the wireless access hotspot device; return an identity identification of the terminal and an authentication algorithm supported by the terminal to the wireless access hotspot device according to a request message for providing the identity identification and the supported authentication algorithm that is sent by the wireless access hotspot device; and receive an authentication result returned by the wireless access hotspot device.

According to an embodiments of the disclosure, the terminal further comprising: a drive loading component, configured to load drive of the functions matched out by the matching component; an application data processing component, configured to after the terminal receives application data sent by the wireless access hotspot device, complete obtaining and interpretation of the application data using a drive installed by the above drive loading component.

According to still another aspect of the embodiments of the disclosure, a system for implementing function sharing in a wireless access hotspot device is provided, comprising: the wireless access hotspot device and at least one terminal; wherein the wireless access hotspot device is configured to send information of a function supported by the wireless access hotspot device itself to a terminal that passed wireless access authentication; receive a function sharing request message returned by the terminal, and obtain from the function sharing request message information of a function the terminal requests to share; the information of the function that is requested to share comprising all kinds of functions that are matched from the information of the function supported by the wireless access hotspot device and are capable of being shared by the terminal; and when the terminal enabling a function in the information of the shared function, send application data corresponding to the function to the terminal in a wireless transmission manner; each terminal is configured to after passing the wireless access authentication, receive from the wireless access hotspot device the information of the function supported by the wireless access hotspot device; match the information of the function supported by the terminal with the information of the function supported by the wireless access hotspot device, and match out all kinds of the functions capable of being shared by the terminal, and send the function sharing request message to the wireless access hotspot device, wherein the matched-out all kinds of functions as the information of the function that is requested to share are carried in the function sharing request message; and when enabling a function in the information of the shared function, receive application data of the function returned by the wireless access hotspot device in a wireless transmission manner. The beneficial effects of the embodiments of the present invention, comprising:

The embodiments of the disclosure provide a method, device, and system for implementing function sharing in a wireless access hotspot device. The wireless access hotspot device can send information of a function supported by itself for a terminal that passed wireless authentication, the terminal matches information of a function supported by itself with the information of the function supported by the wireless access hotspot device to get a function that is requested to share and inform the wireless access hotspot device. The wireless access hotspot device sends corresponding application data when the terminal enables some function that is requested to share. The embodiments of the disclosure use the function of the wireless access hotspot device that can communicate with a plurality of terminals simultaneously to achieve providing corresponding services for the plurality of terminals and function sharing, thus facilitating use for users and making full use of the resources information on a wireless access hotspot device, and solving the problem in the related art that only one user can use application and services on a wireless access hotspot device during some period of time due to that a terminal must be connected the wireless access hotspot in a physical manner.

### BRIEF DESCRIPTION OF THE DRAWINGS

FIG. 1 is flowchart of a method for implementing function sharing in a wireless access hotspot device provided by an embodiment of the disclosure in the wireless access hotspot device;

FIG. 2 is flowchart of the method for implementing function sharing in a wireless access hotspot device provided by an embodiment of the disclosure on a terminal side;

FIG. 3 is flowchart of the method for implementing function sharing in a wireless access hotspot device provided by an embodiment of the disclosure, taking the application GPS as example;

FIG. 4 is a component structure diagram of a wireless access hotspot device provided by an embodiment of the disclosure;

FIG. 5 is a component structure diagram of a terminal provided by an embodiment of the present invention;

FIG. 6 is structure diagram of a system for implementing function sharing in a wireless access hotspot device provided by an embodiment of the disclosure.

### DESCRIPTION OF EMBODIMENTS

The particular embodiments of the method, device and system for implementing function sharing in a wireless access hotspot device provided by the embodiments of the disclosure will be described below in combination with the accompanying drawings in the description.

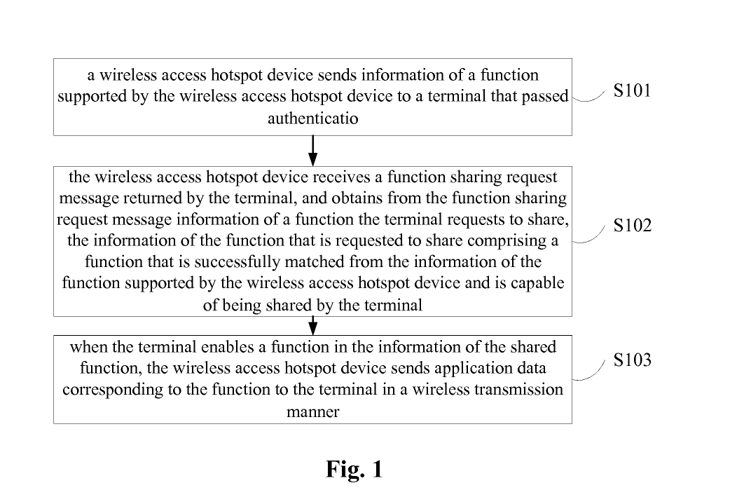

A method for implementing function sharing in a wireless access hotspot device provided by the embodiments of the disclosure, as shown in FIG. 1, on the wireless access hotspot device side, the method specifically comprises the following steps:

Step S101, the wireless access hotspot device sends information of a function supported by the wireless access hotspot device itself to a terminal that passed wireless access authentication;

Step S102, the wireless access hotspot device receives a function sharing request message returned by the terminal, and obtains from the function sharing request message information of a function that the terminal requests to share, the information of the function that is requested to share comprising all kinds of functions that are matched from the information of the function supported by the wireless access hotspot device and are capable of being shared by the terminal; and

Step S103, when the terminal enables a function in the above information of the shared function, the wireless access hotspot device sends application data corresponding to the function to the terminal in a wireless transmission manner.
Further, the wireless access hotspot device is required to authenticate the identity of the terminal, specifically comprises the following steps:

when receiving an access request message sent by the terminal, the wireless access hotspot device sends a message to the terminal requesting access to request the terminal to provide an identity identification and an authentication algorithm supported by the terminal;

the wireless access hotspot device authenticates the terminal for access according to the returned identity identification and the authentication algorithm supported by the terminal.

Further, after the wireless access hotspot device obtains from the function sharing request message the information of the function that the terminal requests to share, the method further comprises: the wireless access hotspot device correspondingly saves the identity identification of the terminal and the received information of the function in the function sharing request message sent by the terminal that the terminal requests to share.

In particular, the wireless access hotspot device can correspondingly store the identity identification of the terminal and the information of the function that the terminal requests to share in a database for convenient maintenance.

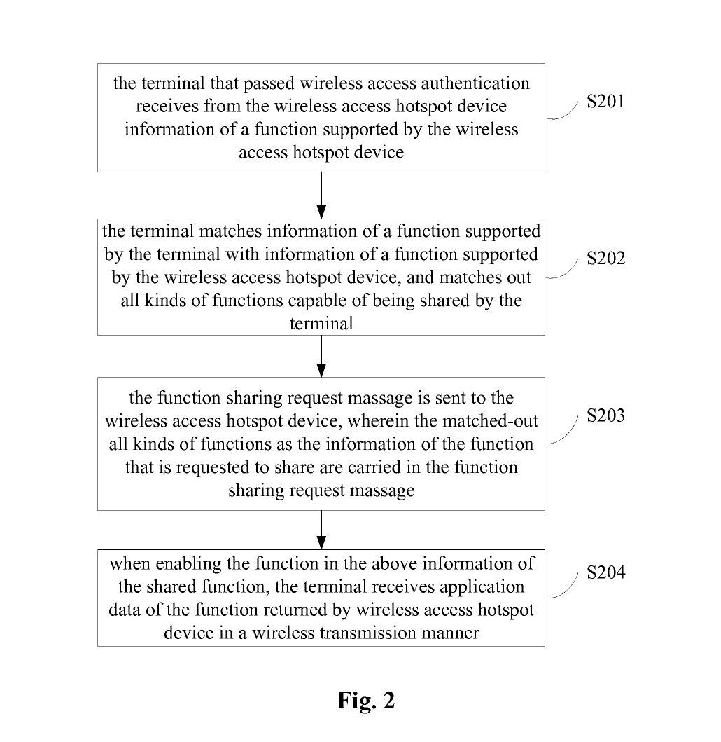

The method for implementing function sharing in a wireless access hotspot device provided by the embodiments of the disclosure, as shown in FIG. 2, on the terminal side, the method specifically comprises the following steps:

Step S201, the terminal that passed wireless access authentication receives from the wireless access hotspot device information of a function supported by the wireless access hotspot device itself;

Step S202, the terminal matches information of a function supported by the terminal with information of a function supported by the wireless access hotspot device, and matches out all kinds of functions capable of being shared by the terminal;

Step S203, the terminal sends a function sharing request message to the wireless access hotspot device, wherein the matched-out kinds of functions as the information of the function that is requested to share are carried in the function sharing request message;

Step S204, when enabling the function in the above information of the shared function, the terminal receives application data of the function returned by wireless access hotspot device in a wireless transmission manner.

Further, the wireless access hotspot device is required to authenticate the identity of the terminal, specifically comprises the following steps:

the terminal sends an access request message to the wireless access hotspot device;

the terminal returns the identity identification of the terminal and the authentication algorithm supported by the terminal to the wireless access hotspot device according to a request message for providing the identity identification and the supported authentication algorithm sent by the wireless access hotspot device;

the terminal receives an authentication result returned by the wireless access hotspot device.

Further, the above method for implementing function sharing in a wireless access hotspot device provided by the embodiments of the disclosure further comprises performing the following steps: after the functions capable of being shared by the terminal are matched out, the terminal loads the drive of the above matched-out all kinds of functions; and after receiving the application data sent by the wireless access hotspot device, the terminal completes obtaining and interpretation of the application data using the above installed drive.

In order to better describe the above method for implementing function sharing in a wireless access hotspot device provided by the embodiments of the disclosure, description is made with a particular embodiment below. It should be noted that since the related network protocols used in the package delivery, unpacking, and packaging involved herein fall within the standard protocols in related art, they are not described redundantly.

As shown in FIG. 3, taking GPS functions as example, the technical solutions of the embodiments of the disclosure are further described:

Step S301, the wireless access hotspot device detects whether there is a terminal to request access, and after finding a request message, sends a message to the terminal generating the access request to request to provide an identity identification and an authentication algorithm supported by the terminal;

Step S302, the terminal requesting access sends its identity identification and supported authentication algorithm to the wireless access hotspot device in a package;

Step S303, after receiving the information of the identity identification of the terminal, the wireless access hotspot authenticates the terminal for legality, and if the terminal passed the authentication, the terminal is allowed to access, and sends package the functions carried by the device, and sends the package to the legal terminal; and if the terminal cannot pass the authentication, the communication is terminated;

Step S304, after receiving a message permitting access, the terminal matches the information of the function received in step S303 with the GPS function supported by the terminal, after successful matching, loads a preset GPS drive; and then the terminal sends a function sharing request message to the wireless access hotspot device to request information related to shared GPS;

Step S305, after receiving the information of a GPS function requested to be shared, the wireless access hotspot device stores the identification of the terminal and the information of the GPS function requested to be shared correspondingly (for example, storing in a database maintained by the wireless access hotspot device itself); and when the terminal enables the GPS, the wireless access hotspot device sends the information related to the GPS acquired by the wireless access hotspot device from the network side to the terminal according to the stored information of the identify identification;

After receiving the information (such as longitude and latitude, name of current place etc.) related to the GPS acquired from the network side that is sent by the wireless access hotspot device, the terminal can acquire and interpret the relevant information provided by the wireless access hotspot device using the information provided by the drive mounted in the step S304.

Preferably, an encryption/decryption function can be added on the wireless access hotspot device side and the network side respectively in the embodiments of the present invention, namely after the terminal passed the authentication performed by the wireless access hotspot device, all the subsequent information is encrypted/decrypted by their respective encryption/decryption component respectively. Since encryption technology is related art technology, it is not described redundantly herein.

Based on the same inventive concept, the embodiments of the present invention also provide a wireless access hotspot device, a terminal and a system for implementing function sharing in the wireless access hotspot device. Because the principles of these devices solving problems are similar to those of the method for implementing function sharing in the previous wireless access hotspot device, the previous method can be referred to for the implementation of the device and system, and the overlapping is not described redundantly.

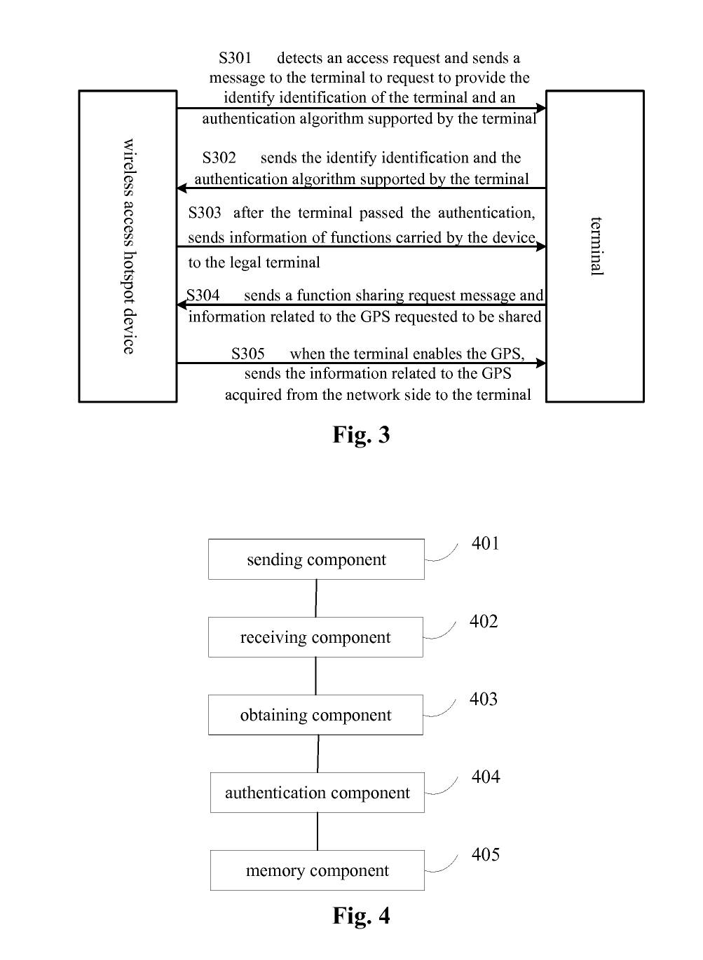

A wireless access hotspot device provided by the embodiments of the disclosure, as shown in FIG. 4, comprises:

a sending component 401, is configured to send information of a function supported by the wireless access hotspot device itself to a terminal that passed wireless access authentication; and when the terminal enabling a function in the information of a function that is requested to share, send application data corresponding to the function to the terminal in a wireless transmission manner; a receiving component 402, connected to the above sending component 401, is configured to receive a function sharing request message returned by the terminal; and an obtaining component 403, connected to the above receiving component 402, is configured to obtain the information of the function that the terminal requests to share from the function sharing request message.

Further, as shown in FIG. 4, the above wireless access hotspot device of the embodiments of the disclosure may further comprises: an authentication component 404, connected to the above obtaining component 403, is configured to when receiving an access request message sent by the terminal, send a message to the terminal requesting access to request the terminal to provide an identity identification and an authentication algorithm supported by the terminal; and authenticate the terminal for access according to the returned identity identification and the authentication algorithm supported by the terminal.

Further, as shown in FIG. 4, the above wireless access hotspot device of the embodiments of the present invention can also comprises a memory component 405, in particular: a memory component 405, connected to the above authentication component 404, is configured to save the identity identification of the terminal and the received information of the function in the function sharing request message that the terminal requests correspondingly after obtaining the information of the function that the terminal requests to share from the function sharing request message received by the terminal.

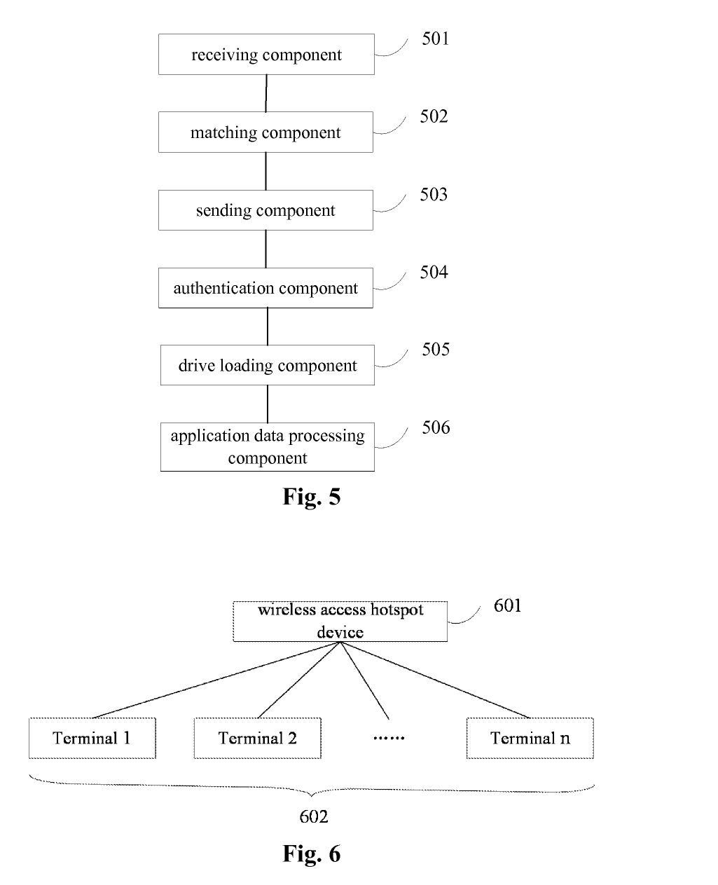

A terminal provided by the embodiments of the present invention, as shown in FIG. 5, comprises:

a receiving component 501, is configured to receive from a wireless access hotspot device information of a function supported by the wireless access hotspot device itself; and when the terminal enables a function in the information of the function that the terminal requests to share, receive application data of the function returned by the wireless access hotspot device in a wireless transmission manner; a matching component 502, connected to the above receiving component 501, is configured to match information of a function supported by the terminal with information of a function supported by the wireless access hotspot device, and match out all kinds of functions capable of being shared by the terminal; a sending component 503, connected to the above matching component 502, is configured to send the function sharing request message to the wireless access hotspot device, wherein the matched-out all kinds of functions capable of being shared by the terminal as the information of the function that is requested to share are carried in the function sharing request message.

Further, as shown in FIG. 5, the above terminal provided by the embodiments of the disclosure may further comprises: an authentication component 504, connected to the above sending component 503, is configured to send an access request message to the wireless access hotspot device; return an identity identification of the terminal and an authentication algorithm supported by the terminal to the wireless access hotspot device according to a request message for providing the identity identification and the supported authentication algorithm that is sent by the wireless access hotspot device; and receive an authentication result returned by the wireless access hotspot device.

Further, as shown in FIG. 5, the terminal provided by the embodiments of the disclosure may further comprises: a drive loading component 505, connected to the above authentication component 504, is configured to load drive of the functions matched out by the matching component; an application data processing component 506, connected to the above drive loading component 505, is configured to, after the terminal receives application data sent by the wireless access hotspot device, complete obtaining and interpretation of the application data using a drive installed by the above drive loading component.

Further, the embodiments of the present invention can also add an encryption/decryption component to the wireless access hotspot device side and the network side respectively, namely after the terminal passes the authentication performed by the wireless access hotspot device, all the subsequent information is encrypted/decrypted by their respective encryption/decryption component respectively. Since encryption technology is related art technology, it is not described redundantly herein.

A system for implementing function sharing in a wireless access hotspot device is provided by the embodiments of the disclosure, as shown in FIG. 6, comprises: a wireless access hotspot device side and at least one terminal, specifically comprises:

the wireless access hotspot device 601, is configured to send information of a function supported by the wireless access hotspot device to a terminal that passed wireless access authentication; receive a function sharing request message returned by the terminal, and obtain from the above function sharing request message information of a function the terminal requests to share; the information of the function that is requested to share comprising all kinds of functions that are successfully matched from the information of the function supported by the wireless access hotspot device and are capable of being shared by the terminal; and when the terminal enables a function in the above information of the shared function, send application data corresponding to the function to the terminal in a wireless transmission manner;

each terminal 602, connected to the above wireless access hotspot device 601, is configured to after passed the wireless access authentication, receive from the wireless access hotspot device the information of the function supported by the wireless access hotspot device itself; match the information of the function supported by the terminal with the information of the function supported by the wireless access hotspot device, and send the function sharing request message to the wireless access hotspot device, wherein the successfully matched-out all kinds of functions as the information of the function that is requested to share are carried in the function sharing request message; and when enabling a function in the information of the shared function, receive application data of the function returned by the wireless access hotspot device in a wireless transmission manner.

The embodiments of the disclosure provide a method, device, and system for implementing function sharing in a wireless access hotspot device. The wireless access hotspot device can send information of a function supported by itself for a terminal that passed wireless authentication, the terminal matches information of a function supported by itself with the information of the function supported by the wireless access hotspot device to get a function that is requested to share and inform the wireless access hotspot device. The wireless access hotspot device sends corresponding application data when the terminal enables some function that is requested to share. The embodiments of the disclosure use the function of the wireless access hotspot device that can communicate with a plurality of terminals simultaneously to achieve providing corresponding services for the plurality of terminals and function sharing, thus facilitating use for users and making full use of the resources information on a wireless access hotspot device, and solving the problem in the related art that only one user can use application and services on a wireless access hotspot device during some period of time due to that a terminal must be connected the wireless access hotspot in a physical manner.

From the description of the above embodiments, those skilled in the art may clearly understand that the embodiments of the present invention can be implemented by hardware, or also by software plus a necessary general purpose hardware platform. Based upon such understanding, the technical solutions of embodiments of the disclosure can be embodied in the form of a software product, which can be stored in a storage medium (CD-ROM, flash memory, mobile HD, etc.) including several instructions to cause a computer device (which may be a private computer, a server, or a network device, etc.) to perform the methods according to the various embodiments of the disclosure. The disclosure can have various modifications and changes, and can be implemented terminals of various forms, and is also not to limited to an embedded system.

It should be understood by persons skilled in the art that the accompanying drawings are merely schematic diagrams of one exemplary embodiment, and components or procedures in the accompanying drawings are not necessarily required in implementing the present invention. Persons skilled in the art may understand that the components in the devices provided in the embodiments may be arranged in the devices in a distributed manner according to the description of the embodiments, or may be arranged in one or multiple devices which are different from those described in the embodiments. The components in the foregoing embodiments may be combined into one component, and may also be split into multiple sub-components.

The sequence numbers of the preceding embodiments of the present invention are merely for description purpose but do not indicate the preference of the embodiments.

Obviously, those skilled in the technical field can implement various modifications and improvements for the present invention, without departing from the scope of the present invention. Thus, if all the modifications and improvements belong to the scope of the claims of the present invention and the similar technologies thereof, the present invention is intended to contain the modifications and improvements.

1. A method for implementing function sharing in a wireless access hotspot device, comprising:
the wireless access hotspot device sending information of a function supported by the wireless access hotspot device itself, to a terminal that passed wireless access authentication;
the wireless access hotspot device obtaining, from a function sharing request message returned by the terminal, a information of a function that the terminal requests to share, wherein the information of the function that is requested to share comprises all kids of functions that are successfully matched from the information of the function supported by the wireless access hotspot device and are capable of being shared by the terminal; and
when the terminal enabling a function in the information of the shared function, the wireless access hotspot device sending application data corresponding to the enabled function to the terminal in a wireless transmission manner.

2. The method according to claim 1, wherein the wireless access hotspot device authenticates the terminal for access, specifically comprises:
when receiving an access request message sent by the terminal, the wireless access hotspot device sends a message to the terminal to request the terminal to provide an identity identification and an authentication algorithm supported by the terminal;
the wireless access hotspot device authenticates the terminal for access according to the returned identity identification and the authentication algorithm supported by the terminal.

3. The method according to claim 1, wherein after the wireless access hotspot device obtains, from the function sharing request message returned by the terminal, information of the function the terminal requests to share, further comprising:
the wireless access hotspot device saving the identity identification of the terminal and the information of the function in the function sharing request message that the terminal requests to share correspondingly.

4. A method for implementing function sharing in a wireless access hotspot device, comprising:
the terminal that passed wireless access authentication receiving from the wireless access hotspot device information of a function supported by the wireless access hotspot device itself;
the terminal matching the information of the function supported by the terminal itself with the information of the function supported by the wireless access hotspot device to match out all kinds of functions capable of being shared by the terminal, and sending a function sharing request message to the wireless access hotspot device,
wherein all kinds of the matched-out functions as the information of the function that is requested to share are carried in the function sharing request message; and
when enabling the function in the information of the shared function, the terminal receiving application data corresponding to the function returned by wireless access hotspot device in a wireless transmission manner.

5. The method according to claim 4, wherein the terminal is required to be authenticated for access, specifically comprises:
sending an access request message to the wireless access hotspot device;
sending the identity identification of the terminal and the authentication algorithm supported by the terminal to the wireless access hotspot device according to a request message for providing the identity identification and the supported authentication algorithm returned by the wireless access hotspot device;
receiving an authentication result returned by the wireless access hotspot device.

6. The method according to claim 4, further comprising: after all kinds of functions capable of being shared by the terminal are matched out, the terminal loading the drive of the matched-out functions; and after receiving the application data sent by the wireless access hotspot device, the terminal completing obtaining and interpretation of the application data using an installed drive.

7. The method according to claim 4, wherein the wireless transmission manner is a wireless fidelity (Wi-Fi) manner.

8. A wireless access hotspot device, comprising:
a sending component, configured to send information of a function supported by the wireless access hotspot device to a terminal that passed wireless access authentication; and when the terminal enabling a function in the information of a function that is requested to share, send application data corresponding to the function to the terminal in a wireless transmission manner;
a receiving component, configured to receive a function sharing request message returned by the terminal; and
an obtaining component, configured to obtain the information of the function that the terminal requests to share from the function sharing request message.

9. The wireless access hotspot device according to claim 8, further comprising:
an authentication component, configured to when receiving an access request message sent by the terminal, send a message to the terminal requesting access to request the terminal to provide an identity identification and an authentication algorithm supported by the terminal; and authenticate the terminal for access according to the returned identity identification and the authentication algorithm supported by the terminal.

10. The wireless access hotspot device according to claim 8 or 9, further comprising: a memory component, configured to after obtaining the information of the function that the terminal requests to share from the function sharing request message, save the identity identification of the terminal and the received information of the function in the function sharing request message that the terminal requests correspondingly.

11. A terminal, comprising:
a receiving component, configured to receive from a wireless access hotspot device information of a function supported by the wireless access hotspot device itself; and
when the terminal enables a function in the information of the function that is requested to share, receive application data of the function returned by the wireless access hotspot device in a wireless transmission manner;
a matching component, configured to match information of a function supported by the terminal with information of a function supported by the wireless access hotspot device, and match out all kinds of functions capable of being shared by the terminal;
a sending component, configured to send the function sharing request message to the wireless access hotspot device, wherein the matched-out functions capable of being shared by the terminal as the information of the function that is requested to share are carried in the function sharing request message.

12. The terminal according to claim 11, further comprising:
an authentication component, configured to send an access request message to the wireless access hotspot device; return an identity identification of the terminal and an authentication algorithm supported by the terminal to the wireless access hotspot device according to a request message sent by the wireless access hotspot device for providing the identity identification and the supported authentication algorithm; and receive an authentication result returned by the wireless access hotspot device.

13. The terminal according to claim 11, further comprising:
a drive loading component, configured to load drive of the functions matched out by the matching component; and
an application data processing component, configured to after the terminal receives application data sent by the wireless access hotspot device, complete obtaining and interpretation of the application data using a drive installed by the above drive loading component.

14. A system for implementing function sharing in a wireless access hotspot device, comprising: the wireless access hotspot device and at least one terminal; wherein:
the wireless access hotspot device is configured to send information of a function supported by the wireless access hotspot device itself to a terminal that passed wireless access authentication; receive a function sharing request message returned by the terminal, and obtain from the function sharing request message information of a function the terminal requests to share; the information of the function that is requested to share comprising all kinds of functions that are matched from the information of the function supported by the wireless access hotspot device and are capable of being shared by the terminal; and when the terminal enabling a function in the information of the shared function, send application data corresponding to the function to the terminal in a wireless transmission manner;
each terminal is configured to after passed the wireless access authentication, receive from the wireless access hotspot device the information of the function supported by the wireless access hotspot device itself; match the information of the function supported by the terminal with the information of the function supported by the wireless access hotspot device, and match out all kinds of functions capable of being shared by the terminal, and send the function sharing request message to the wireless access hotspot device, wherein the matched-out all kinds of functions as the information of the function that is requested to share are carried in the function sharing request message; and when enabling a function in the information of the shared function, receive application data of the function returned by the wireless access hotspot device in a wireless transmission manner.

15. The method according to claim 2, wherein after the wireless access hotspot device obtains, from the function sharing request message returned by the terminal, information of the function the terminal requests to share, further comprising:
the wireless access hotspot device saving the identity identification of the terminal and the information of the function in the function sharing request message that the terminal requests to share correspondingly.

16. The method according to claim 5, wherein the wireless transmission manner is a wireless fidelity (Wi-Fi) manner.

17. The method according to claim 6, wherein the wireless transmission manner is a wireless fidelity (Wi-Fi) manner.

18. The wireless access hotspot device according to claim 9, further comprising: a memory component, configured to after obtaining the information of the function that the terminal requests to share from the function sharing request message, save the identity identification of the terminal and the received information of the function in the function sharing request message that the terminal requests correspondingly.
